(19) United States
(12) Patent Application Publication
(10) Pub. No.: US 2007/0118766 A1
(43) Pub. Date: May 24, 2007

(54) Electronic content security scheme

(75) Inventor: Ricky Li Fo Sjoe, Soquel, CA (US)

Correspondence Address: Naomi Obinata, 10427 Avenida Lane, Cupertino, CA, 95014, US

(73) Assignee: Molino Networks, Inc.

(21) Appl. No.: 11/056,546

(22) Filed: Feb. 11, 2005

(51) Int. Cl. H04L 9/32; G06F 12/14; G06F 17/30; G06F 7/04; G06F 11/30; H03M 1/68; G06K 9/00; H04K 1/00; H04L 9/00; H04N 7/16

(52) U.S. Cl. 713/193; 726/27

(57) ABSTRACT

A method has been developed for enhanced content protection for use in a DVD player or other apparatus where it is desired to store content in a secure manner for personal use and enjoyment. By this technique, a user could input content into an apparatus, and store a single copy of the content in a storage library within the apparatus in encrypted form. When the user is ready to enjoy the content, the user triggers a decryption algorithm to be run on the stored content for viewing, audio or both. The encryption/decryption algorithms are designed to avoid the likelihood of hacking into and retrieving the content from storage. Whereupon, numerous volumes of content may be retrieved for viewing or audio listening with assurance that the content is locked into its storage library.

### CROSS-REFERENCE TO RELATED APPLICATIONS

Not applicable.

### BACKGROUND OF THE INVENTION

There has been much concern by content-owners, in both the music industry and the movie industry in particular, about the potential revenue loss due to unauthorized (unlicensed, and therefore non-revenue bearing) copying of copyrighted material. The target of this concern has been not only the actual copiers, but those such as hardware, software and service providers, who have been perceived as enabling such copying.

The Copyright Act in the United States recognizes that certain acts are “fair use” which are not acts of infringement. More recently, however, legislation such as the Digital Millennium Copyright Act (DMCA), has been enacted to more closely control activities surrounding copyrighted material.

Designers and users of consumer electronics devices and systems that handle copyrighted content are well advised to consider the implications of the various legislation relating to handling copyrighted content.

A concern that copyright legislation is aimed at protecting against is the ability to hack into an electronic device and reproduce the contents of stored material without authorization. Typically, if there is any copy protection at all, the protection is limited to a single, uniformly used protection key. Once the uniformly used protection key is identified, then a hacker can easily decrypt the content and enjoy it without paying for the content.

By providing a fairly minimal protection for the copyrighted content, then for content security, the suppliers of content seem to place greater reliance upon the user's own sense for the right and wrong usages of the material. But when copying becomes facilitated through the digitization of the content, then copying becomes a matter of transferring bits of data, through electronic media, and the likelihood of unfair use of the material grows. At the same time, with the advent of larger and larger electronic storage capabilities, consumers have a greater desire to store the material in a single, easy to retrieve location, to enjoy the material easily without any intention of violating the copyright law.

If users are allowed the freedom to store material electronically in a single location and retrieve the desired material on demand with the single push of a button, users may be inclined to purchase more content in the first place. But of course, with the interest in storing material electronically, there is a greater demand for electronic content and, there comes a greater likelihood people desiring to cheat the copyright system. It therefore is important to create new ways to protect the material to secure it in its electronic library location.

### BRIEF SUMMARY OF THE INVENTION

There is described herein an apparatus and process for enabling the enhanced protection of content that is transmitted within an electronic device. The enhanced protection scheme includes a content importer as well as a content protection scheme interconnected with the content importer, wherein the content protection scheme includes an encryptor, a key generator, and a data processor for implementing a pre-defined algorithm for conducting the encryption and key generation. The content is stored on a storage device that allows for a plurality of unique content to be stored. The content is stored in encrypted form and may be played only by first decrypting the storage format for the content.

An embodiment of the invention in the context of a DVD (“Digital Video Disc”) is described. A DVD content playback system includes a rewritable storage medium (such as a hard drive) that stores DVD content. The system also includes processing to emulate “playback” of the DVD content from the rewritable storage medium as if the DVD content were actually being played directly (i.e., discounting the inevitable existence of some buffer circuitry) from a DVD storage medium. Processing is also included to minimize the probability that the DVD content can be exported outside the system from the rewritable storage medium. In one example, the DVD content is stored on the rewritable storage medium and encrypted in a manner that depends on unique characteristics of the DVD content playback system and, in some cases, unique characteristics of the DVD (at least, unique to that “title” of content).

### BRIEF DESCRIPTION OF THE DRAWINGS

FIG. 1 illustrates, in block form, an example of an electronic device having content protection included therein.

FIG. 2 illustrates an exemplary content protection process implementing an embodiment of the invention.

FIG. 3 is a block diagram of an embodiment of the content protection method of the invention.

FIG. 4 is a block diagram of the use of the invention in the context of a DVD.

### DETAILED DESCRIPTION OF THE INVENTION

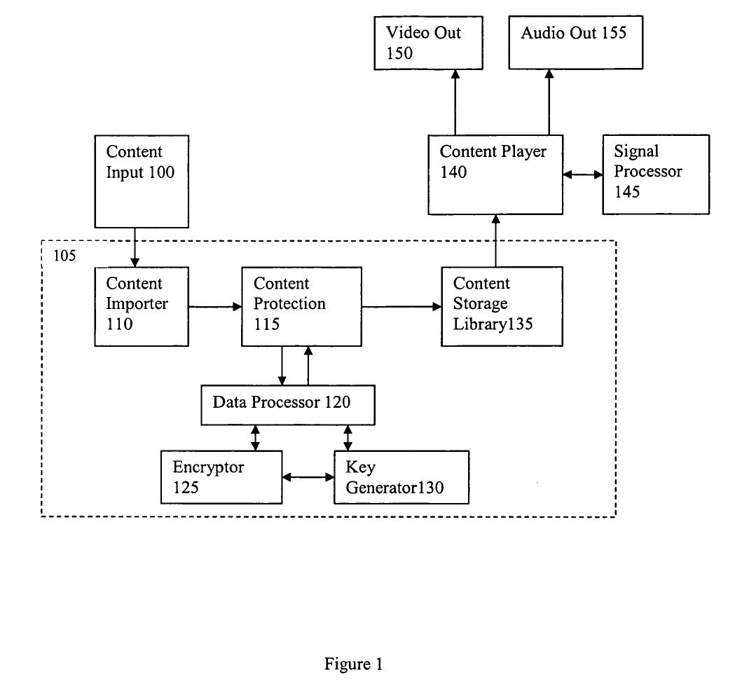

FIG. 1 is a block diagram of an electronic device utilizing an embodiment of the invention. The electronic device of FIG. 1 is generally a box that includes a computing device. The electronic device contains an input port for content, such as a reader for an optical disk, and a processor for enabling the transport of data from the content to storage while implementing security algorithms designed to allow for a single copy to be made of a piece of content for storage preferably within the same box. The box of FIG. 1 may further include storage media for creating electronic libraries of content input to the box, and a player for sensory enjoyment of the content. If desired, the box of FIG. 1 may include Ethernet or other contacts to the worldwide internet and an integrated viewing screen. There is an input for content 100. Content 100 may be any content, preferably in digital form, for which copy protection is desired such as a video, audio, or still picture. The content 100 is placed within a media content security scheme 105. Therein is included a content importer 110, which enables the copying of the content onto a storage device. Content importer 110 is preferably a software algorithm that when implemented, causes data from content 100 to be read, a file created, and transported to a storage medium so as to create a file library 135. Prior to content 100 data being transported into electronic storage, a content protection algorithm 115 is implemented to cause the content 100 data tobe encoded. When the algorithm 115 is run, files from content 100 are transported into a data processor 120 (via a bus, which is not shown) where the content protection algorithm 115 triggers an encryptor 125 to run and cause the content 100 files to become scrambled. The data processor 120 may be any microprocessor capable of processing mathematical functions on data, preferably in at least 32 bit blocks. The encryptor 125 calls a key generator 130 to create a unique key for content 100 encrypted files. Whereupon, the content 100 files are transmitted out of the data processor (via a bus, which is not shown) in encrypted form, and sent to content storage library 135. Content storage library 135 stores content 100 files in encrypted form for security purposes. Content storage library 135 may be ahard disk, flash memory or other storage medium that enables the permanent storage of content for use and enjoyment by an end user.

When the user is ready to enjoy the content, the user enables the content player 140. Content player 140 is a component that, among other things, retrieves digital data from the content storage library 135 and converts the digital data into a format that is viewable or audible or both. To achieve sensory enjoyment for the user, the content player 140 first virtually re-implements content protection algorithm 115 to regenerate a key from key generator 130 to decrypt the content 100 files via the encryptor 125. Throughout this protected content retrieval process, data processor 120 applies the necessary algorithms to cause the content protection algorithm 115 to run through a signal processor 145, for instance, a graphics processor. Whereupon, a secure reproduction of content 100 then is output to either a video out 150 or audio out 155 for the user's personal enjoyment.

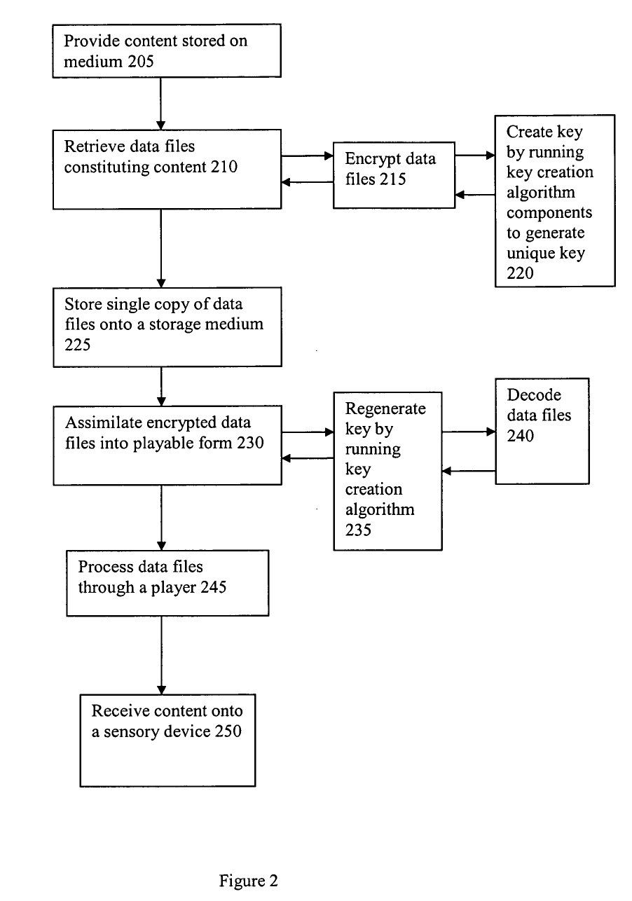

The process that occurs in the device of FIG. 1 is illustrated in block form in FIG. 2. First, content is provided that has been placed on a medium 205 such as an optical disk. Then, upon command by the user, the content 205 is processed through a data file retrieval 210 step. There, data files are retrieved from the content medium 205 and an encryption algorithm 215 is applied to the data files. The encryption algorithm 215 uses a combination of pre-selected numbers and calls upon a key generator to scramble the data files into unreadable form 220. Next, the encoded data files are stored in a single copy onto a storage medium 225. The storage medium may be a writeable disk drive or semiconductor-based memory such as flash memory. The key created at step 220 is used for encoding purposes but the key itself is not stored in storage medium 225. When a user desires to play the content 205, the user issues a command that triggers the step of assimilating the data files into a playable form 230. The assimilation step 230 is similar to step 215. A key is regenerated 235 by applying the algorithm that generated the key for the encryption in the first place, at step 215, 220. The key regeneration step 235 enables the data files to be decrypted or decoded 240. When the decoding step 240 is complete, the data files are ready to be played. The regenerated key from step 235 is not stored in storage medium 225. The data files are transmitted to a player 245. This step includes, among other things, applying video and audio processing sequences to the data to format the data into a viewable or audible form. Finally, the data files are transmitted to a sensory device 250 such as a television display, an audio receiver or other device that allows sensory enjoyment of the content 205. It should be noted that step 245 can not be implemented unless assimilation step 230 is first done.

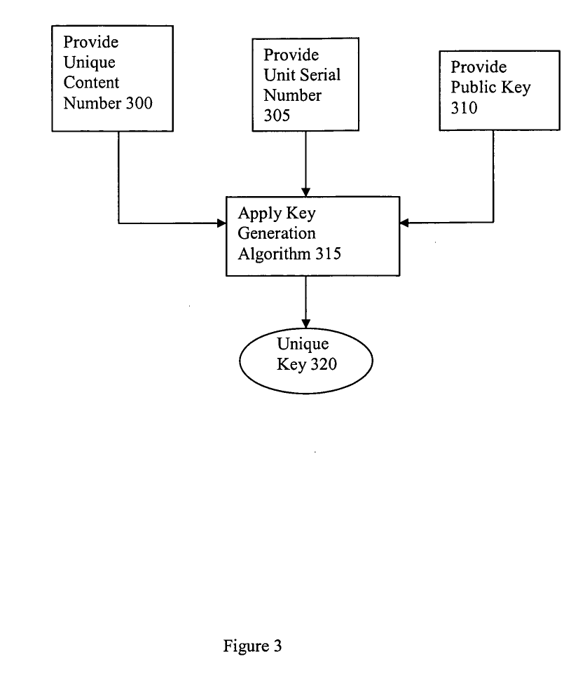

FIG. 3 illustrates the key generation step in block diagram form. Preferably, there are three components used for creating a unique key. Each of the components is derived in a manner suitable to the programmer of the security device, but each component is identified and derived in a pre-defined manner selected by the programmer of the security device. There is first a number based upon the particular content 300. Content number 300 may be derived from the volume label for the content or another source for the content number 300 based upon the content itself could be used. Second, there is a number that is based upon the device identifier 305, for instance, the serial number of the device such as that shown in FIG. 1. The device identifier number 305 may be alternatively an Ethernet MAC address for the device or another convenient, fixed number preferably related to the device itself. Third, another number, for instance, a public key 310 is provided. A public key 310 may be issued by any commercial source. The three numbers 300, 305 and 310 may be the actual numbers themselves, but preferably are composed of a derivation of the original numbers, where the derivation is performed in a manner defined by or known only to the person programming the security aspect of the device. To these three numbers, an algorithm for creating a secret key is applied 315. Preferably, the algorithm is an AES algorithm that results in a 128-bit unique key 320. The actual manner that the algorithm is used on the three numbers 300, 305 and 310 to create the unique key 320 is selected and implemented by the programmer of the security mogul and is written preferably in the language C, using programming skills typical of a person ordinarily skilled in the art. The programmer creates a program that causes the same secret 128-bit key 320 to be output for the three numbers 300, 305 and 310. Key 320 is created during the encryption process and is not stored in the storage medium 135 referred to in FIG. 1. Instead, when a user wishes to play encrypted content, a key 320 is recreated, preferably using the same three input numbers, and used to decrypt and prepare the content for enjoyment in a player.

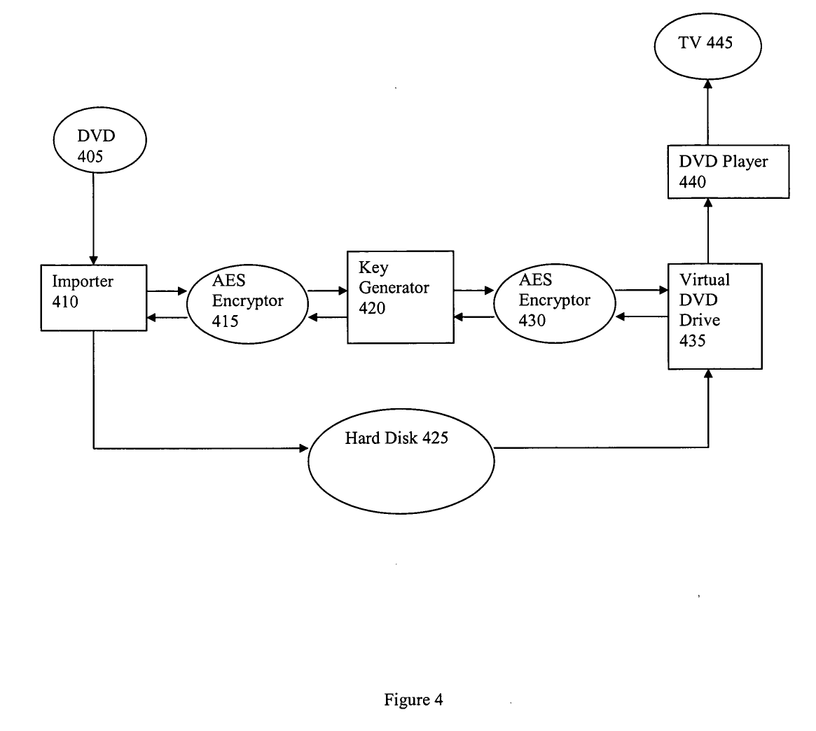

Referring now to FIG. 4, an example DVD content playback system 400 is illustrated in block form. Generally speaking, the system 400 includes elements to copy content from a DVD-formatted optical disc 405 onto a preferably rewritable storage medium 425 such as a hard drive or semiconductor-based memory such as a flash memory. Rewritable storage medium 425 may also be implemented in software. The DVD 405 content is replayed via suitable playback equipment such as through a television 445. The processing of the system 400, in general, may be executed by a general purpose computer programmed in a manner so as to carry out the needed processing of digital data.

The importer process 410 is configured to retrieve the contents of the disc 405 in its entirety and saving a corresponding disc image to the storage medium 425. During the process of saving the contents of the disc 405 to the storage medium 425, an encryption process 415 encrypts the disc contents using a key provided by a key generator process 420. The key generator process 420 uses, in part, an indicator that is unique to a particular DVD title to generate the key. The key generator process may operate according to an AES algorithm and may be a 128-bit key. The system 400 operates in such a way as to preserve the copy protection benefits of CSS.

That is, the DVD standard format includes a copy protection requirement known as Content Scrambling System, or CSS. Basically, as envisioned by the CSS license, each CSS licensee is given a key from a master set of keys stored on every CSS-encrypted disc. At playback, the CSS decryption algorithm operating within a standard DVD player or computer exchanges keys with the drive unit to generate an encryption key that is then used by the drive unit to encrypt the CSS disc keys and title keys before passing them to the player playback process.

Turning back to the import process 410, at no time during the import process 410 are the CSS keys in cleartext format. Rather, like the standard CSS decrypting algorithm operating within a standard DVD player or computer, the importer process 410 negotiates a session key with the DVD drive, and the CSS keys are retrieved from the DVD drive directly in an encrypted format. The encrypted CSS keys are stored on the storage device 425.

Furthermore, as part of the importer process 410, the volume label from the DVD content is stored (e.g., in the first 32K bytes) in a header section of the DVD file on the storage device 425. In one case, a unique brand identifier (for instance, “MOLINO”) is stored into the header also. Then the CSS-encrypted CSS keys, further AES encrypted, are stored in the header section. In addition, to bind the DVD image to a particular system, a system-unique identification is placed in the header section and the title-unique identifier is also placed in the header section. Finally, the entire header section is secured with a secured hash value (signed using a public key) to further guard against tampering.

To “play back” the DVD using the system 400, the process is roughly symmetrical to that just described to store the DVD image on the storage device 400. First, a virtual DVD drive 435 causes a decryption process 430 to decrypt the DVD image using a key generated by the key generator process 420. It is noted that, even if the key is compromised, this only compromises a particular DVD title.

The play back process also includes processing to ensure that the DVD image has been bound to the system 400. That is, the secured hash value is validated; if the secured hash value is invalid, then the header has been tampered. Furthermore, the data that is nominally the system-unique identification, that was placed in the header section during the import process, is compared to a system-unique identification of the playback system 400. If there is a mismatch, then the DVD image was potentially surreptitiously placed on the system 400, and playback is prohibited.

Once the DVD image is decrypted and the secured hash value is validated, the virtual DVD drive process and the DVD player process 440 operate in a conventional manner.

The preferred embodiments of the invention have been described in general terms as well as in the context of a DVD. The invention may be applied to other contexts as well for which enhanced protection schemes may be desired, for instance, still pictures, audio, or text. Although the present invention has been described in reference to particular embodiments, persons of ordinary skill in the art will recognize that changes may be made in form and detail without departing from the spirit and scope of the invention, as claimed below.

What is claimed as new and desired to be protected by Letters Patent of the United States is:

1. An integrated apparatus for enabling protection of content that is stored within an electronic device, comprising:
a content importer;
a content protection scheme interconnected with the content importer, wherein the content protection scheme includes an encryptor, a key generator, and a data processor for implementing a pre-defined algorithm for conducting the encryption and key generation; and
a content storage device that allows for a plurality of unique content to be stored, wherein the content is electronically locked into the content storage device in encrypted form, such that the content may be enjoyed by first decrypting the content by implementing a pre-defined algorithm for key generation and then transporting the content to a player.

2. An integrated apparatus for enhanced content protection as in claim 1, wherein the player is coupled to the content storage device.

3. An integrated apparatus for enhanced content protection as in claim 1, wherein said encryptor utilizes an AES algorithm.

4. An apparatus for enhanced content protection as in claim 1, wherein said encryptor uses at least three preselected numbers for creating a unique key.

5. A method of storing content within an electronic device in a secure manner, comprising the steps of:
providing content that has been placed on a medium into the electronic device;
retrieving data from the content, wherein the data retrieval step includes the steps of encrypting the data and creating a key by applying a pre-defined algorithm;
storing a copy of the data onto a storage medium in an encrypted form; and
prior to playing the content, assimilating the encrypted data into a playable form.

6. A method of storing content as in claim 5, wherein the step of encrypting the data includes generating a 128-bit key.

7. A method of storing content as in claim 5, further comprising the step of processing the decoded data through a player for sensory enjoyment by a user.

8. A method of storing content as in claim 5, wherein the step of encrypting the data includes generating a key that is a function of at least three previously defined numbers.

9. A method of storing content as in claim 8, wherein the step of generating the 128 bit key further includes implementing an AES algorithm.

10. A method executing in a DVD hardware apparatus comprising:
generating an encryption key, wherein the encryption key is a function of unique characteristics of both the DVD and the hardware apparatus;
receiving data from the DVD;
encrypting the data using the generated encryption key; and
storing the encrypted data.

11. A method as in claim 10, wherein:
the DVD data is encrypted on the DVD according to a CSS algorithm and includes at least one DVD key encrypted according to a CSS encryption key; and
the data receiving step includes receiving the at least one DVD key with CSS-decrypting the at least one DVD key.

12. A method as in claim 11, further including the step of using a CSS access key to access the encrypted at least one DVD key.

13. A method as in claim 10, wherein the generated encryption key is an AES key.

14. A method as in claim 10, wherein the generated encryption key is a 128 bit key.

15. A method of securing digital content in a storage medium for subsequent playback on a player, including the steps of:
encrypting the digital content so that the digital content is stored in an encrypted form, wherein the encrypting is performed using a unique key derived a first instance from a plurality of previously defined numbers;
storing the encrypted digital content in the storage medium;
deriving the unique key in a second instance; and
using the unique key derived in the second instance to decrypt the digital content to allow the digital content to be played.
